(19) United States
(12) Patent Application Publication
(10) Pub. No.: US 2024/0037378 A1
(43) Pub. Date: Feb. 1, 2024

(54) ACCELERATED SCALE-OUT PERFORMANCE OF DEEP LEARNING TRAINING WORKLOAD WITH EMBEDDING TABLES

(71) Applicant: Intel Corporation, Santa Clara, CA (US)

(72) Inventors: Guokai Ma, Shanghai (CN); Jiong Gong, Shanghai (CN); Dhiraj Kalamkar, Bangalore (IN); Rachitha Prem Seelin, Santa Clara, CA (US); Hongzhen Liu, Santa Clara, CA (US); Akshay Jain, Santa Clara, CA (US); Liangang Zhang, Santa Clara, CA (US)

(73) Assignee: Intel Corporation, Santa Clara, CA (US)

(21) Appl. No.: 18/255,391

(22) PCT Filed: Dec. 24, 2020
(86) PCT No.: PCT/CN2020/000318

§ 371 Date: Jun. 1, 2023

(51) Int. Cl. G06N 3/063; G06N 3/084

(52) U.S. Cl. CPC G06N 3/063; G06N 3/084

(57) ABSTRACT

Systems, apparatuses and methods may provide for technology that identifies an embedding table associated with a neural network. The neural network is associated with a plurality of compute nodes. The technology further identifies a number of entries of the embedding table, and determines whether to process gradients associated with the embedding table as dense gradients or sparse gradients based on the number of entries.

### TECHNICAL FIELD

Embodiments generally relate to neural networks (e.g., deep learning networks). More particularly, embodiments relate to embedding tables for neural networks.

### BACKGROUND

Neural networks may include embedding tables that contain many entries of vectors. Input data may have indexes to these embedding tables. In a forward pass (which may be referred to as forward propagation), indexes may be used to lookup entries in these embedding tables. The look up result may be referred to as a lookup entry, or sparse feature (e.g., lookup entry). In a backward pass, a gradient to each lookup entry may be computed and the weights in these embedding tables may be updated using the gradients.

### BRIEF DESCRIPTION OF THE DRAWINGS

The various advantages of the embodiments will become apparent to one skilled in the art by reading the following specification and appended claims, and by referencing the following drawings, in which:

FIG. 1 is a process flow diagram of an example of a neural network training process according to an embodiment;

FIG. 2 is a flowchart of an example of a method of processing an embedding table according to an embodiment;

FIG. 3 is a block diagram of an example of a neural network architecture according to an embodiment;

FIG. 4 is a flowchart of an example of a method of processing a deep learning workload according to an embodiment;

FIG. 5 is a flowchart of an example of a method of dividing an embedding table according to an embodiment;

FIG. 6 is a process flow diagram of an example of a vertical split process according to an embodiment;

FIG. 7 is a process flow diagram of an example of an all-to-all operation according to an embodiment;

FIG. 8 is a flowchart of an example of a method of dividing a plurality of embedding tables according to an embodiment;

FIG. 9 is a block diagram of an example of a performance-enhanced computing system according to an embodiment;

FIG. 10 is an illustration of an example of a semiconductor apparatus according to an embodiment;

FIG. 11 is a block diagram of an example of a processor according to an embodiment; and

FIG. 12 is a block diagram of an example of a multi-processor based computing system according to an embodiment.

### DESCRIPTION OF EMBODIMENTS

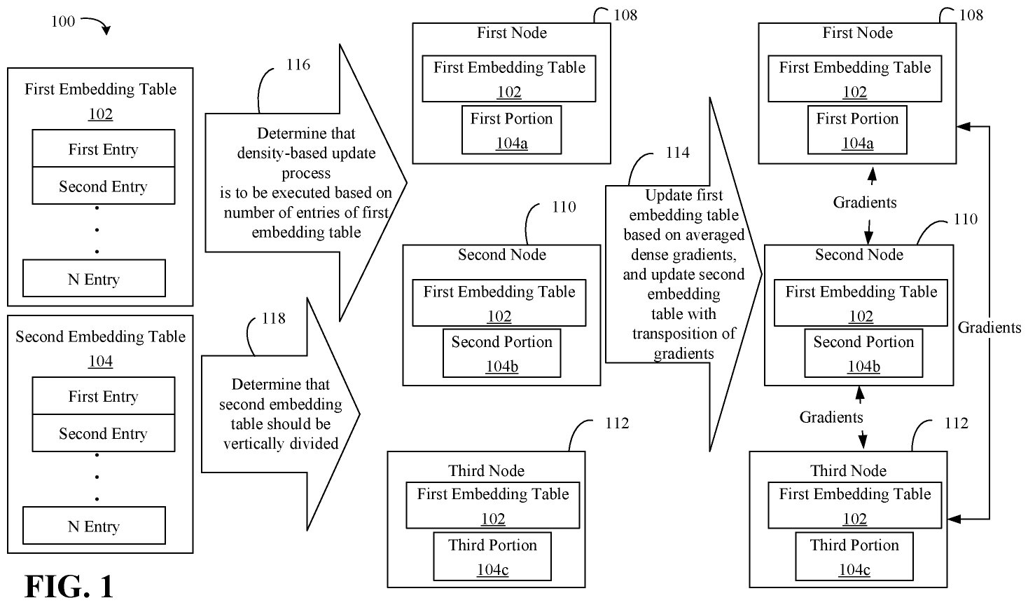

Turning now to FIG. 1, an enhanced neural network training process 100 (e.g., deep learning that is a machine learning process) is illustrated. In detail, in FIG. 1 a first embedding table 102 and second embedding table 104 include a series of first-N entries that may be different from each other. The first-N entries of each of the first embedding table 102 and the second embedding table 104 may include weights that are trained (e.g., adjusted) over iterations. For example, a first node 108, a second node 110 and a third node 112 may access the entries in each of the first embedding table 102 and the second embedding table 104 to process workloads during a forward pass (e.g., forward propagation), and adjust weights accordingly based on gradients identified during a backwards pass (e.g., backpropagation) following the forward pass.

As will be described in further detail below, some embodiments may include enhanced communication of gradients between the first node 108, the second node 110 and the third node 112 to reduce communication costs (e.g., latency, bandwidth, etc.)

during at least the backward pass. For example, some embodiments may include treating small embedding table gradients associated with the first embedding table 102 as dense gradients and communicating gradient averages (e.g., an allreduce operation that generates an average across ranks or nodes) as opposed to tuples associated with each specific index that is to be updated (e.g., a sparse allreduce operation that would otherwise be used for small embedding table gradients) which may have a longer latency, incur more costly communications, and increase memory footprints.

For example, a sparse allreduce operation may differ in the sending “index+value” from allreduce. In input values of an allreduce operation, a value with same index has same offset in the input value of the rank. This allows an advanced algorithm to finish allreduce in O(N) (where N is the size of input). Sparse allreduce cannot have such an advanced algorithm and may finish in O(N*p) (where N is the size of input, and p is the number of nodes).

Further, some embodiments may vertically split an embedding table, such as the second embedding table 104, to facilitate multi-node processing of the embedding table, reduce memory and reduce communication costs. For example, some embodiments split large sized embedding tables vertically into multiple embedding tables with a same number of entries (e.g., rows) as the original large sized table, where each table has a decreased vector size (e.g., only a subset of the columns) in the original table, and then a lookup process is executed (e.g., an action that extracts a subset of the table entries according to lookup index), and then an exchange and contact operation for the extracted table entries is executed to generate full vectors (e.g., full column size)for a subset of the extracted table entries. Doing so reduces total time to train (TTT) and allows efficient scale-out to multiple model instance. Indeed, such implementations facilitates training models with embedding tables in less TTT and still maintain efficient utilization of hardware resources. On a model instance with small host/device memory, such embodiment also allows further reduced memory requirement with scale out.

In detail, the first embedding table 102 may include a number of table entries (e.g., first entry-N entry). Process 100 may determine that the number of table entries is below a threshold to be considered sufficiently “small” to be stored in most memory devices, while also benefitting from modified communication protocols. While some applications may treat the first embedding table 102 as a sparse table due to data sparsity, embodiments as described herein may treat the first embedding table 102 as a dense table, to update model instances according to dense gradients. Specifically, the choice of whether the first and second embedding tables 102, 104 benefit from turning sparse gradient updates into dense gradient updates may depend on a batch size per instance, a number of entries in the table, and number of instances, and may be agnostic to vector length of each entry. Thus, the process 100 may select whether to treat the gradients as dense or sparse based on the above factors to bypass identifying whether the first embedding table 102 and/or the second embedding table 104 is actually sparse (e.g., only a subset of the features is used during inference of an input data) or is dense (e.g., all or nearly all of the features are used for gradient updates).

For example, assume a table, such as the first embedding table 102, has T entries (e.g., rows), each entry has V bytes (e.g., a total number of byes to update one or more gradients in an entry), and a local batch size is b, a number of instances is p, and network bandwidth is BW. With a sparse gradient update (e.g., sparse allreduce), after local gradients are computed, in worst case min(T, b) needs to be broadcasted to all other instances (e.g., nodes that contain the table), thus communication time is given by Equation 1:

$${t}_{sparseall \_ reduce} = \frac{min ( T , b ) \cdot V \cdot ( p - 1 )}{BW} \qquad Equation 1$$

With a dense gradient update (e.g., allreduce), with a small latency, the communication time is given by Equation 2:

$${t}_{allreduce} = \frac{2 \cdot \frac{p - 1}{p} \cdot T \cdot V}{BW} \qquad Equation 2$$

With these two formulas, the dense gradient update (e.g., allreduce time) will be less than the sparse gradient update (e.g., sparse allreduce time) when the following condition is true:

$$2 \cdot \frac{T}{p} < min ( T , b ) \to T < b \cdot \frac{p}{2} , \qquad Condition 1$$

$$p \geq 2 \to T < \frac{global\_bs}{2} , p \geq 2$$

In this example, the process 100 identifies that the number of entries in the first embedding table 102 is less than half the global batch size. Therefore, process 100 determines that a dense-based update process (e.g., allreduce) is to be executed based on the number of entries of the first embedding table 102, 116. In some embodiments, in the case of p>=2, 2*T/p will always<=T. Thus, whether 2*T/p<min(T,b) depends on whether 2*T/p<b. Some embodiments may have T as being relatively small and smaller than B, but such cases may not define the boundary of T for the inequality.

In contrast, the second embedding table 104 may be larger than half the global batch size to determine that the second embedding table 104 is too large to benefit from a dense-based gradient update. Process 100 may therefore determine that the second embedding table 104 should be vertically divided 118. For example, the second embedding table 104 may be split into a plurality of local embedding tables (e.g., three) with a third vector length. The lookup entries are transposed among the local embedding tables and the results are contacted together into entries with full vector length to generate first portion 104a of the second embedding table 104, second portion 104b of the second embedding table 104, and third portion 104c of the second embedding table 104.

Some embodiments may employ a model parallelism. For example, each of the first node 108, the second node 110 and the third node 112 (which may each correspond to a “worker”) include model instances that include first embedding table 102, and a respective one of the first portion 104a, the second portion 104b and the third portion 104c. From the viewpoint of the first node 108, the first portion 104a belongs to the first node 108, while the second node 110 owns the second portion 104b and the third node 112 owns the third portion 104c. Thus, the first node 108 may communicate (e.g., exchange gradients) with the second and third nodes 110, 112 to provide gradient updates and/or data to the second and third nodes 110, 112 for the second and third portions 104b, 104c respectively. For example, the first node 108 may receive data (e.g., entries) of the second portion and third portions 104b, 104c from the second node 110 and the third node 112 respectively during forward propagation. During backward propagation, the first node 108 may provide gradients, associated with the received data, to the second node 110 and the third node 112 so that the second node 110 and the third node 112 adjust weights of the second portion 104b and the third portion 104c.

Similarly, the second node 110 may exchange data and/or exchange gradient updates associated with the first portion 104a and the third portion 104c with the first and third nodes 108, 112 respectively. Moreover, the third node 112 may exchange data and/or exchange gradient updates associated with the first portion 104a and the second portion 104b with the first and second nodes 108, 110 respectively.

Dividing the second embedding table 104 into the first portion 104a, the second portion 104b and the third portion 104c may result in lower latency communications and memory accesses. For example, the second embedding table 104 may be far too large to be stored in any the memory of any one of the first node 108, second node 110 or third node 112. The first portion 104a, the second portion 104b and the third portion 104c may respectively be small enough to be stored in the memory of the first node 108, the memory of the second node 110 and the memory of the third node 112. Doing so may avoid costly memory accesses to slower memory. Furthermore, dividing the second embedding table 104 may permit slower communication protocols to be avoided (e.g., sparse allreduce operations). Rather, the data and/or weights may be directly communicated between the first node 108, second node 110 and third node 112 through more efficient protocols (e.g., transpose). Additionally, greater scale-ups may be realized across a larger array of computing devices and with greater access to diverse execution units (e.g., accelerators having limited memory capacities).

The first node 108, the second node 110 and the third node 112 may execute a forward pass over a batch and based on the first embedding table 102 as well as the first portion 104a, second portion 104b and third portion 104c. During a corresponding backward pass, the process 100 may update the first embedding table 102 in each model instance of the first node, 108, second node 110 and third node 112 as well as the first portion 104a, second portion 104b and third portion 104c. For example, process 100 may update the first embedding table 102 based on averaged dense gradients for first embedding table 102, and update second embedding table 104 with transposition (e.g., exchanging data values and/or gradients, may also be referred to as an all-to-all operation) 114 of gradients. Thus, gradients lookup entries will be computed and the weights in the first embedding table 102 and the first portion 104a, the second portion 104b and the third portion 104c will be updated using lookup entry weight gradients.

The average of the gradients may be determined by a single node of the first node 108, the second node 110 and the third node 112. In some embodiments, the first node 108, the second node 110 and the third node 112 may operate together to determine the average of the gradients.

Some embodiments may employ an “Allreduce operation” to average the gradient across the first node 108, the second node 110 and the third node 112 in a training application to update the first embedding table 102. Further, the second embedding table 104 may be divided into first portion 104a, the second portion 104b and third portion 104c and updated with transposition operations.

For example, some designs execute forward propagation based on sparse features because only a subset of the features is used during inference of an input data. That is, only those features in table entries marked by a table index in input data are used. In a sparse allreduce operation during backward stage, only those weights that were used during the forward pass are updated, while other unused weights are not updated. Such a sparse allreduce operation to update a particular embedding table may significantly increase communication and latency costs (e.g., time costs) impeding scale-out. For example, the latency of the sparse allreduce operation may be proportional to a number of instances of the particular embedding table that are distributed across various locations and/or nodes. Further, communication costs may increase if there are multiple instances of the table entries replicated in multiple locations or workers (e.g., compute nodes) that are updated by specific references (e.g., tuples each with an index and numerous gradients to update entries associated with the index) to table entries.

Moreover, sparse allreduce executions may incur significant memory footprint costs since larger sized embedding tables would need to be replicated across different workers (e.g., compute nodes) to execute. Such memory space to store a larger sized embedding table may not exist on some devices, such as graphics processor, accelerator or central processing unit. Furthermore, some implementations may employ a hybrid parallelism in which each embedding table (including a larger embedding table) is controlled (e.g., pass values from the embedding table and update the weights in the embedding table based on received data from the other workers) by one worker. In such implementations however, the number of workers will equal the number of the embedding tables limiting scaling.

In some embodiments as described herein, rather than using sparse allreduce for larger size embedding tables or constraining scalability as in the hybrid parallelism model, the embodiments divide the larger sized embedding table to bypass sparse allreduce operations and allowing scale-up to multiple workers (e.g., compute nodes), similar to as described above with respect to the second embedding table 104. Furthermore, embodiments as described herein may bypass replication of larger sized tables, while permitting replication of smaller sized tables may to reduce the memory footprint while also balancing communication costs and processing times.

Furthermore, as noted the second embedding table 104 may be updated according to a transposition operation, which may be referred to as an all-to-all operation. The all-to-all operation may have less communication cost than a sparse allreduce operation. For example, the reason that all-to-all has less communication cost than sparse allreduce is because in the case of sparse allreduce, the embedding table is replicated on all model instances (e.g., compute nodes), so any gradient needs to be sent to every instance to update every weight replica. While in all-to-all case, there is only one embedding table divided among model instances, meaning a gradient only needs to be sent to exactly one instance, resulting in a great saving of the need to transfer data. In addition to that, because each instance holds smaller and less embedding tables, the memory requirement on each instance is much smaller than using sparse allreduce.

In detail, to compare the communication cost for sparse allreduce operation and all-to-all operation, suppose a global batch is b, and there are p tables with vector length V (in bytes). The number of model instances equals to p. To facilitate understanding, a number of tables may be referred to as p_{table}, and number of instances may be referred to p_{instance}, and p=p_{table}=P_{instance}. Then local batch size is b/p_{instance}. With sparse allreduce, communication time is given by Equation 3:

$${t}_{sparseall \_ reduce} = \frac{\frac{b}{{p}_{instance}} \cdot [ sizeof ( index ) + V ] \cdot ( {p}_{instance} - 1 ) \cdot {p}_{table}}{{network}_{bandwidth}} = \frac{b \cdot [ sizeof ( index ) + V ] \cdot ( p - 1 )}{{network}_{bandwidth}} \qquad Equation 3$$

With all-to-all operations, a communication time needed to count in forward all-to-all (e.g., exchanging data for specific entries for processing) time and backward all-to-all time (e.g., exchanging gradient updates), may be provided by Equation 4:

$${t}_{alltoall} = \frac{2 \cdot \frac{p - 1}{p} \cdot b \cdot V}{{network}_{bandwodth}} \qquad Equation 4$$

In order to compare the time for sparse allreduce to all-to all, the following equation 5 is derived:

$$\frac{{t}_{sparseall \_ reduce}}{{t}_{alltoall}} = [ sizeof ( index ) + V ] / 2 \cdot p \cdot V = \frac{p}{2} \cdot \frac{[ sizeof ( index ) + V ]}{V} > 1 , when p \geq 2 \qquad Equation 5$$

Thus, sparse allreduce time is longer than all-to-all time. As such, some embodiments may avoid sparse allreduce operations.

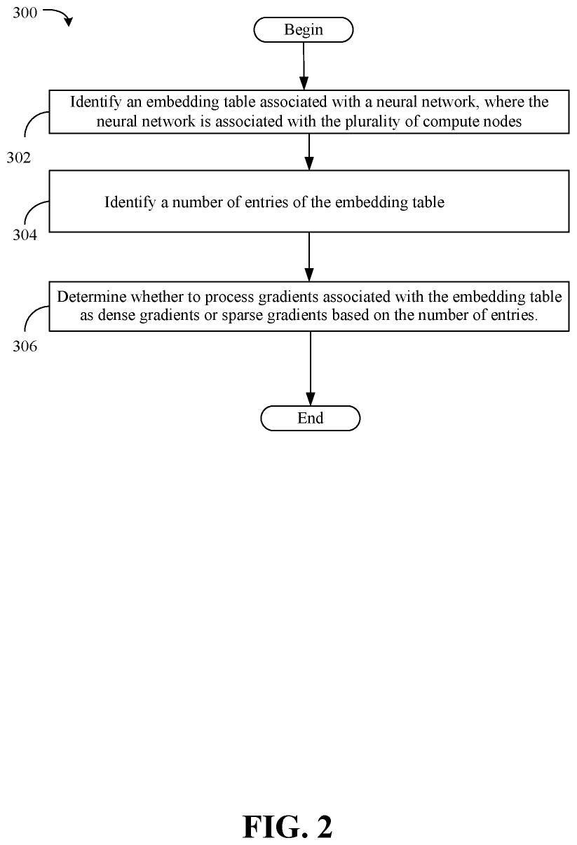

FIG. 2 shows a method 300 of processing an embedding table. The method 300 may generally be implemented in the process 100 (FIG. 1), already discussed. More particularly, the method 300 may be implemented as one or more modules in a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), FPGAs, complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 300 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 302 identifies an embedding table associated with a neural network, where the neural network is associated with the plurality of compute nodes. Illustrated processing block 304 identifies a number of entries of the embedding table. Illustrated processing block 306 determines whether to process gradients associated with the embedding table as dense gradients or sparse gradients based on the number of entries. In some embodiments, method 300 compares the number of entries to a threshold to determine whether to process the gradients associated with the embedding table as the dense gradients or the sparse gradients. For example, the threshold is generated based on a batch size for processing by the neural network.

In some embodiments, method 300 determines that the gradients associated with the embedding table will be processed as the dense gradients, maintains a plurality of instances of the embedding table in the plurality of compute nodes, generates sparse gradients during a machine learning process that is executed based on the embedding table, maps the sparse gradients generated during the machine learning process to generated dense gradients, averages the generated dense gradients, and updates the plurality of instances based on the generated dense gradients.

In some embodiments, method 300 executes a vertical division process on the embedding table to generate a plurality of subdivided embedding tables, where each of the plurality of subdivided embedding tables is less than an identified memory capacity associated with the plurality of compute nodes. The method 300 further distributes the plurality of subdivided embedding tables to the plurality of compute nodes. In some examples, the neural network is a deep learning neural network.

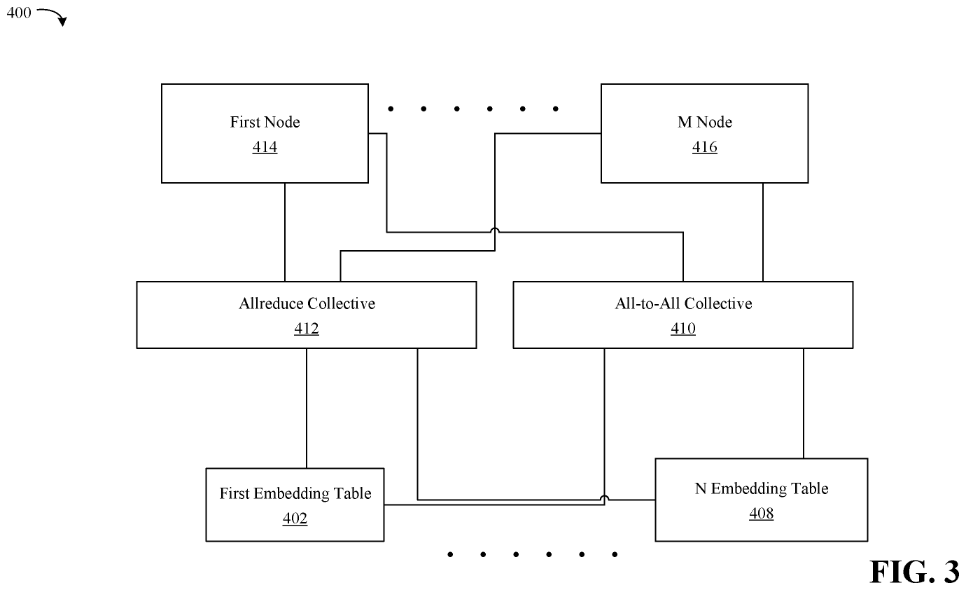

FIG. 3 illustrates a neural network architecture 400 to be used in conjunction with and/or implement aspects of the embodiments described herein, such as the process 100 (FIG. 1) and/or method 300 (FIG. 2). As illustrated, first embedding table 402 to N embedding table 408 are illustrated. Some embodiments may include an Allreduce collective 412 (e.g., to execute dense based gradient updates) to calculate and/or provide gradients of one or more of the first embedding table 402 to N embedding table 408 that is marked and/or treated as a dense embedding table (e.g., average gradients during a backward pass pertaining to each lookup entry or sparse entry and update the corresponding entry accordingly). The all-to-all collective 410 may further generate updates and/or gradient updates during the backward pass for tables that are not treated as dense tables, or divided (e.g., execute transposition) according to embodiments described herein. The first node 414-M node 416 may process batches based on the first embedding table 402-N embedding table 408.

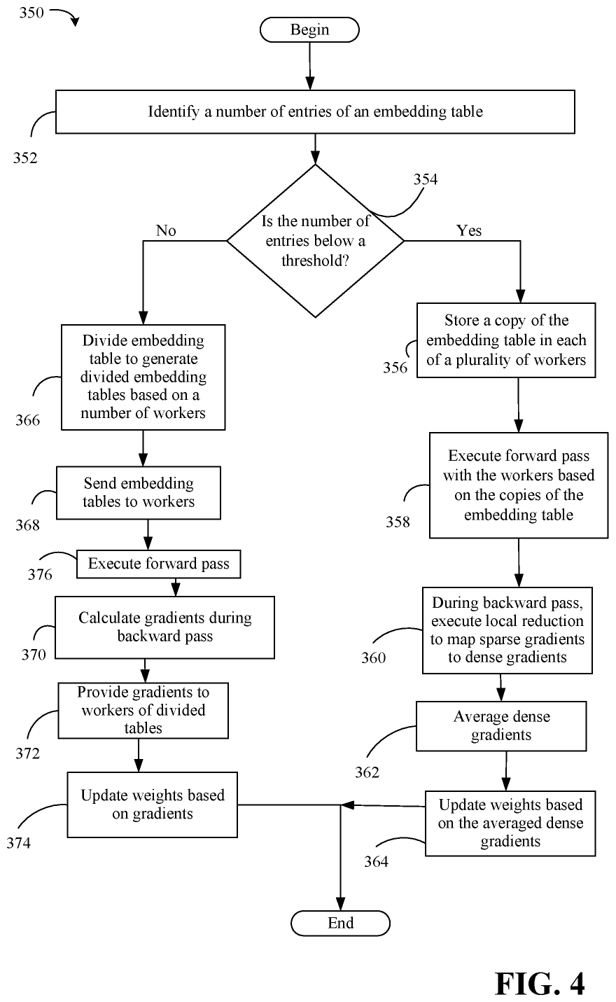

FIG. 4 shows a method 350 of processing a deep learning workload and embedding tables. The method 350 may readily be used in conjunction with and/or implement aspects of the process 100, and/or method 300 already discussed. More particularly, the method 300 may be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 352 identifies a number of entries of an embedding table. Illustrated processing block 354 determines if the number of entries of the embedding table is below a threshold. In some embodiments, the threshold is determined based on a global batch size (e.g., the threshold may be half the global batch size). If the number of entries is below the threshold, illustrated processing block 356 stores a copy of the embedding table in each of a plurality of workers (e.g., compute nodes which may be computing devices). Illustrated processing block 358 executes a forward pass with the workers based on the copies of the embedding table. Illustrated processing block 360 executes during a backward pass immediately following the forward pass, local reduction to map sparse gradients to dense gradients. In some embodiments, illustrated processing block 360 creates one or more initial dense gradients with all values=0 and dimension sizes identical to the embedding table. For each sparse gradient, processing block 360 identifies its index, adds the gradient to the respective lines in dense gradient. Illustrated processing block 360 may further determine that when all sparse gradients are added to dense gradients, the local reduction is done. In some embodiments, illustrated processing block 360 may implement the local reduction by finding duplicate indices across a minibatch(s) and reducing corresponding gradient rows. In some embodiments, separate kernels may be implemented for sparse gradient computation and dense gradient computation and no explicit sparse gradient may be computed while computing dense gradient.

Illustrated processing block 362 averages the dense gradients (e.g., using an allreduce operation). Illustrated processing block 364 updates weights in each of the copies based on the averaged dense gradients.

If illustrated processing block 354 determines that the number of entries is not below the threshold, illustrated processing block 366 divides the embedding table to generate divided embedding tables based on a number of workers (e.g., the number of divided embedding tables is equal to the number of workers). Illustrated processing block 368 sends different embedding tables to different workers (e.g., in a one-to-one correspondence) so that each worker includes only one of the divided embedding tables. Illustrated processing block 376 execute a forward pass based on the embedding tables. Illustrated processing block 370 calculates gradients during a backward pass immediately following the forward pass. Illustrated processing block 372 provides the gradients to workers of the divided tables. For example, a gradient calculated by a second node may be associated with a specific entry in a first of the divided tables that is owned (e.g., stored) by a first node of the nodes. Thus, the second node may transmit the gradient (e.g., using a transposition function) to the first node so the first node may update the specific entry based on the gradient. Likewise, each of the nodes may generate gradients to update entries associated with other nodes, and transmit the gradients to the other nodes as appropriate. Illustrated processing block 374 updates weights based on the gradients.

In some embodiments, method 350 may be repeat for each embedding table in a data model. For example, some applications may include a plurality of embedding tables that are each processed according to method 350, to divide a plurality of tables into divided embedding tables.

For example, suppose a number of instances (or workers) is p, and a model has multiple (N) embedding tables. Suppose the number of p is evenly divisible by N to generate an integer (e.g., p is divided an exact number of times such that there is nothing left over), for examples such that g=p/N. We may label “g” as the group number. For each embedding table, method 350 may repeat to divide the table into “g” tables. Thus, there may be are g*N=p embedding tables after the vertical split. The method 350 may store one embedding table on each model instance, lookup each table with global batch, then use an all-to-all operation to transpose the lookup entries among instances. Thereafter, entries may be concatenated that belonging to the same original embedding table together, then go through the upper layers as in data parallelism.

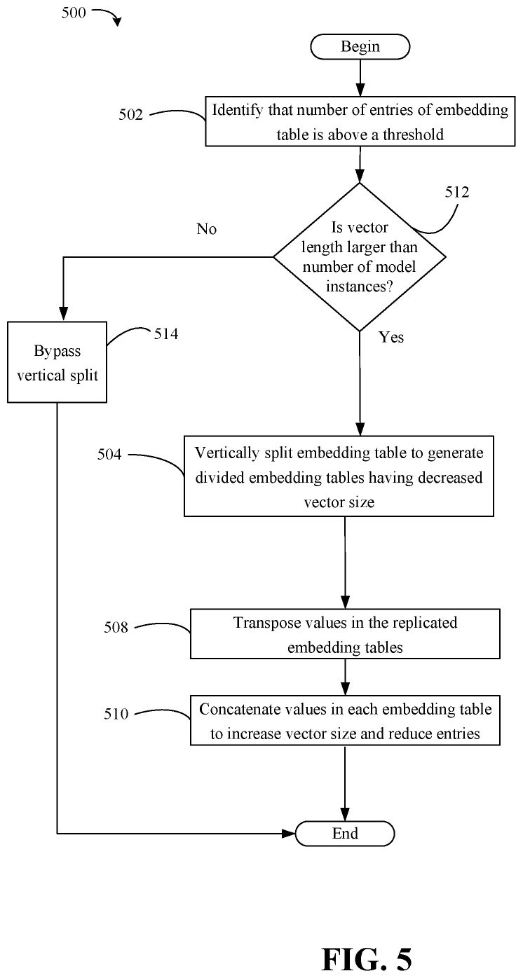

FIG. 5 shows a method 500 of dividing an embedding table according to a vertical split. The method 500 may readily be used in conjunction with and/or implement aspects of the embodiments described herein, such as the process 100 (FIG. 1), method 300 (FIG. 2), architecture 400 (FIG. 3) and/or method 350 (FIG. 4). More particularly, the method 300 may be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 502 determines that a number of entries of the embedding table is above a threshold. For example, illustrated processing block 502 determines that the embedding table is sufficiently large to bypass treating the embedding table as a dense table (e.g., bypass averaging gradients and dense table communication protocols) since a communication cost will not be reduced by treating the embedding table as a dense table. Illustrated processing block 512 determines if the vector length is larger than a number of model instances (e.g., nodes and/or workers). If not, illustrated processing block 514 bypasses the vertical split. Otherwise, if the vector length is larger than a number of model instances, embodiments may avoid sparse operations (e.g., sparse allreduce) through the vertical split.

For example, illustrated processing block 504 vertically splits the embedding table to generate divided embedding tables having a decreased vector size. For example, suppose there are p model instances operating on corresponding workers, and an embedding table with T entries and vector length is V bytes where V is divisible by p (e.g., evenly divisible). Illustrated processing block 504 generates p embedding tables, table0 . . . tablep-1 that each of has a vector length V/p. Each table_0 entry hold element byte [0, V/p), and each table_1 entry hold element byte [V/p, 2*V/p), etc. In this way the original embedding table may be split into p embedding tables.

Illustrated processing block 508 may transpose values in the embedding tables to place original vector values together in different entries. Since the number of embedding tables is equal to number of instances, an all-to-all method may transpose the embedding tables among model instances. Illustrated processing block 510 concatenates values in each embedding table to increase the vector size while reducing the entries (e.g., entries are moved into a same vector) to obtain the full-length sparse feature.

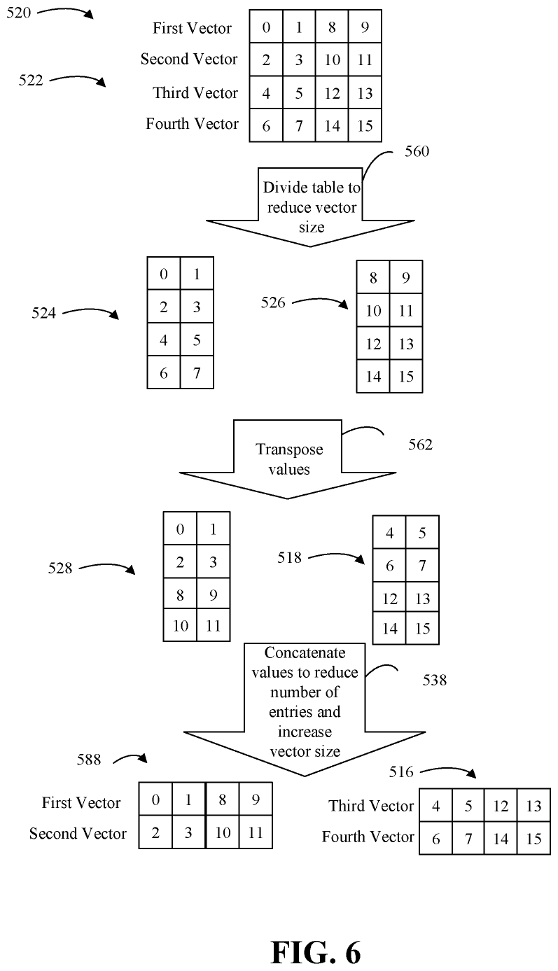

FIG. 6 illustrates a vertical split process 520. The vertical split process 520 may readily be used in conjunction with and/or implement aspects of the embodiments described herein, such as the process 100 (FIG. 1), method 300 (FIG. 2), architecture 400 (FIG. 3), 350 (FIG. 4) and/or method 500 (FIG. 5). An embedding table 522 may include 4 vectors (e.g., 4 rows) each having a vector size of 4 (e.g., 4 columns). For example, the first vector includes values 0, 1, 8, 9, the second vector includes 2, 3, 10, 11, the third vector includes 4, 5, 12, 13 and the fourth vector includes 6, 7, 14, 15. The embedding table 522 may be vertically split. For example, the process 520 divides the embedding table 522 to decrease the vector size 560 and generate first divided embedding table 524 and second divided embedding table 526. It is worthwhile to note that the original vector size of the embedding table 566 is reduced so that the vector size of the first divided embedding table 524 is 2 (e.g., 2 columns) and second divided embedding table 526 is 2 (e.g., 2 columns).

Process 520 transposes values 562 between the first and second divided embedding tables, 524, 526. At this point, the original vector values are in a same table. For example, the values of the first and second vectors are in first divided embedding table 528, while the values of third and fourth vectors are in the second divided embedding table 518. It is worthwhile to note however that the values are not properly aligned (e.g., placed in different vectors or rows). To properly align the vectors, process 520 concatenates values to reduce a number of the entries while increasing the vector size 538. At this time, a first divided embedding table 588 includes the first vector and the second vector that are now properly aligned, and a second divided embedding table 516 includes the third and fourth vectors properly aligned. The first divided embedding table 588 may be provided to a first node or worker who owns the first divided embedding table 588, and the second divided embedding table 516 may be provided to a second node or worker who owns the second divided embedding table 516. Forward and backward propagation processes may thus be executed based on the first divided embedding table 588 and the second divided embedding table 516.

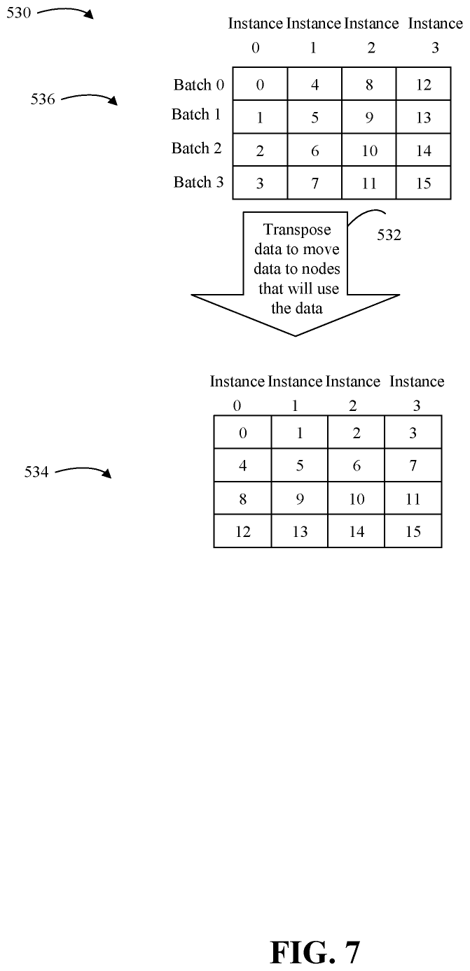

FIG. 7 illustrates an all-to-all operation 530 that ‘transposes’ data chunks between instances. The all-to-all operation 530 may be used in conjunction with and/or be readily implement aspects of the embodiments described herein, such as the process 100 (FIG. 1), method 300 (FIG. 2), architecture 400 (FIG. 3), 350 (FIG. 4), method 500 (FIG. 5) and/or process 520 (FIG. 6).

Before the data is transposed (e.g., all-to-all is executed), each instance 0-3 (e.g., worker) holds data for a global batch. After all-to-all, data belonging to other instances is sent to other model instances, and data belonging to local instances is received from other model instances. Each of instance 0-3 may operate on a different node (e.g., nodes 0-4

All-to-all operation 530 transposes data chunks between 4 model instances. Each column of the table represents data on a local memory of a compute node that includes the respective instance of instances 0-3. Each column may include values that represent look up entries of different instances of instances 0-3. Each row of the first table 536 represents table entries that belongs to a same batch, and so this row may be transposed with the all-to-all operation 530, so all data needed by each model instance would be moved to local memory of that model instance 0-3. Thus, operation 530 transposes data to move data to nodes that will use the data 532 to generate updated table 534. The updated table 534 reflects data in each of the instances 0-3 as distributed to the respective nodes 0-3.

During backward propagation, gradients may be upgraded according to the all-to-all operation 530 so that each lookup entry would be computed and the all-to-all operation 530 would transpose the gradients (e.g., data) again to appropriate instances of the instances 0-3. For example, the operation 530 may collect gradients of lookup entries to the same portion of the table 534 of a same instance (e.g., column), then update local embedding tables with local gradients.

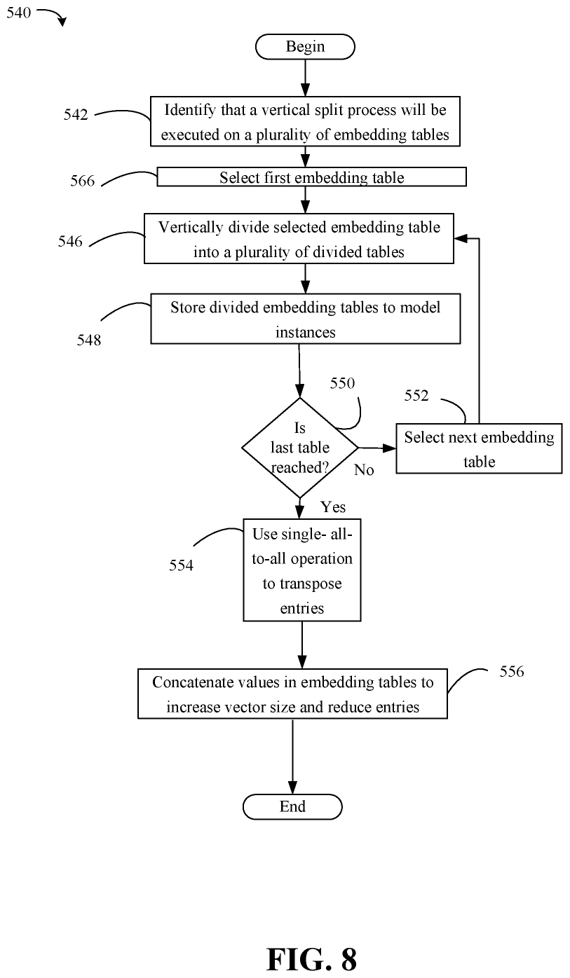

FIG. 8 shows a method 540 of dividing a plurality of embedding tables according to a vertical split process that employs a single transposition operation for all entries. The method 540 may readily be used in conjunction with and/or implement aspects of the embodiments described herein, such as the process 100 (FIG. 1), method 300 (FIG. 2), architecture 400 (FIG. 3), 350 (FIG. 4), method 500 (FIG. 5), process 520 (FIG. 6) and/or operation 530 (FIG. 7). More particularly, the method 540 may be implemented as one or more modules in a set of logic instructions stored in a machine-or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 542 identifies that a vertical split process will be executed on a plurality of embedding tables. Illustrated processing block 544 selects a first embedding table from the plurality of embedding tables. Illustrated processing block 546 vertically divides the selected embedding tables into a plurality of divided tables. Illustrated processing block 548 stores divided embedding tables to model instances. Illustrated processing block 550 determines if the last table is reached. If not, illustrated processing block 552 selects a next embedding table and processing block 546 executes again. Otherwise, a single all-to-all operation transposes entries 554. Illustrated processing block 556 concatenates values in embedding tables to increase vector size and reduce entries.

For example, suppose a number of instances (or workers) is p, and a model has multiple (N) embedding tables. Suppose the number of p is evenly divisible by N to generate an integer (e.g., p is divided an exact number of times such that there is nothing left over), for examples such that g=p/N. We may label “g” as the group number. For each embedding table, method 540 may repeat to divide the table into “g” tables. Thus, there may be are g*N=p embedding tables after the vertical split executes by processing block 546. Thereafter, entries may be modified as already described to be transposed and concatenated, then go through the upper layers as in data parallelism.

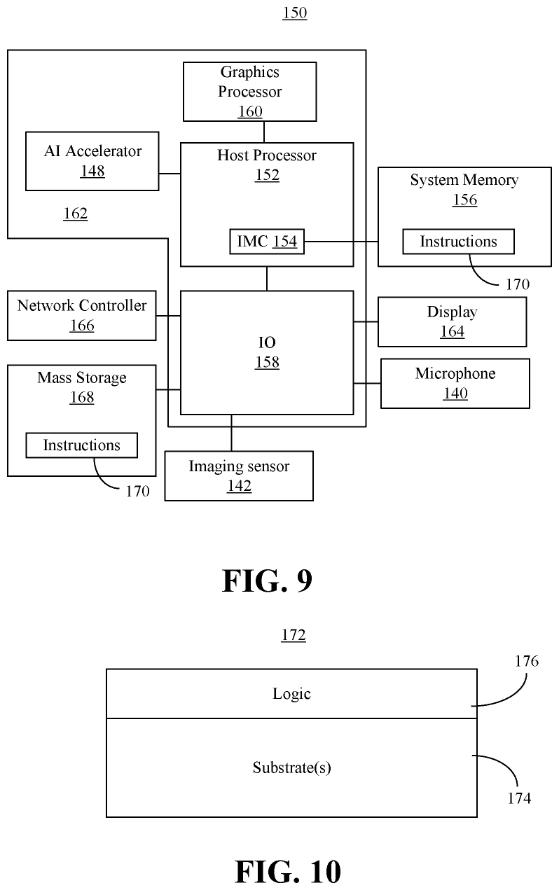

Turning now to FIG. 9, an enhanced neural network computing system 150 is shown that facilitates lower memory usage, as well as low latency communications and reduced synchronization times between compute nodes of the neural network to enhance training and overall performance. The system 150 may be a compute node of the neural network in some examples. The neural network may be a deep learning neural network that classifies images and/or sounds (e.g., words). For example, the neural network may be a recommendation system and/or language model system.

The system 150 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), etc., or any combination thereof. In the illustrated example, the system 150 includes a host processor 152 (e.g., CPU) having an integrated memory controller (IMC) 154 that is coupled to a system memory 156.

The illustrated system 150 also includes an input output (10) module 158 implemented together with the host processor 152 and a graphics processor 160 (e.g., GPU) on a semiconductor die 162 as a system on chip (SoC). The illustrated IO module 158 communicates with, for example, a display 164 (e.g., touch screen, liquid crystal display/LCD, light emitting diode/LED display), a network controller 166 (e.g., wired and/or wireless), and mass storage 168 (e.g., hard disk drive/HDD, optical disk, solid state drive/SSD, flash memory). In some embodiments, the system 150 may further include processors and/or AI accelerators 148 dedicated to artificial intelligence (AI) and/or neural network (NN) processing (deep neural network processing). For example, the system SoC 162 may include vision processing units (VPUs,) and/or other AI/NN-specific processors such as AI accelerator 148, etc. In some embodiments, any aspect of the embodiments described herein may be implemented in one or more of the processors and/or accelerators such as AI accelerator 148 dedicated to AI and/or NN processing, the graphics processor 160 and/or the host processor 152.

The host processor 152, the graphics processor 160 and/or the IO module 158 may execute instructions 170 retrieved from the system memory 156 and/or the mass storage 168. In an embodiment, the computing system 150 is operated in as part of the neural network and the instructions 170 include executable program instructions to perform one or more aspects of the method 300 (FIG. 2), architecture 400 (FIG. 3), method 350 (FIG. 4), method 500 (FIG. 5), process 520 (FIG. 6), operation 530 (FIG. 7) and/or method 540 (FIG. 8) already discussed. Thus, execution of the illustrated instructions 170 may cause the computing system 150 to identify an embedding table associated with the neural network, where the neural network is associated with the compute nodes, identify a number of entries of the embedding table, and determine whether to process gradients associated with the embedding table as dense gradients or sparse gradients based on the number of entries.

The system 150 may further include an imaging sensor 142 and microphone 140 to receive sensor data. For example, a user may issue a verbal command to the system 150 through the microphone 140. In some embodiments, the network controller 166 may register a command, gradient, and/or data update associated with the neural network issued from another device coupled and remote to the system 150. The imaging sensor 142 may capture images to determine and process image data.

The illustrated computing system 150 is therefore considered to be performance-enhanced at least to the extent that it enables the computing system 150 takes advantage of low latency communication and operate at a reduced memory footprint. Doing so enables a multitude of enhancements, including lower processing time, reduced power footprints due to the efficiencies noted herein, and/or enhanced hardware allocations.

FIG. 10 shows a semiconductor apparatus 172 (e.g., chip, die, package). The illustrated apparatus 172 includes one or more substrates 174 (e.g., silicon, sapphire, gallium arsenide) and logic 176 (e.g., transistor array and other integrated circuit/IC components) coupled to the substrate(s) 174. In an embodiment, the apparatus 172 is part of a neural network (e.g., connected to and/or a part of a plurality of compute nodes) and the logic 176 performs one or more aspects of method 300 (FIG. 2), architecture 400 (FIG. 3), method 350 (FIG. 4), method 500 (FIG. 5), process 520 (FIG. 6), operation 530 (FIG. 7) and/or method 540 (FIG. 8) already discussed. Thus, the logic 176 may identify an embedding table associated with the neural network, wherein the neural network is associated with the compute nodes, identify a number of entries of the embedding table, and determine whether to process gradients associated with the embedding table as dense gradients or sparse gradients based on the number of entries.

The logic 176 may be implemented at least partly in configurable logic or fixed-functionality hardware logic. In one example, the logic 176 includes transistor channel regions that are positioned (e.g., embedded) within the substrate(s) 174. Thus, the interface between the logic 176 and the substrate(s) 174 may not be an abrupt junction. The logic 176 may also be considered to include an epitaxial layer that is grown on an initial wafer of the substrate(s) 174.

In some embodiments, the logic 176 may further include processors (not shown) and/or accelerators (not shown) dedicated to AI and/or NN processing. For example, the logic 176 may include VPUs, and/or other AI/NN-specific processors, etc. In some embodiments, any aspect of the embodiments described herein may be implemented in the processors and/or accelerators dedicated to AI and/ or NN processing.

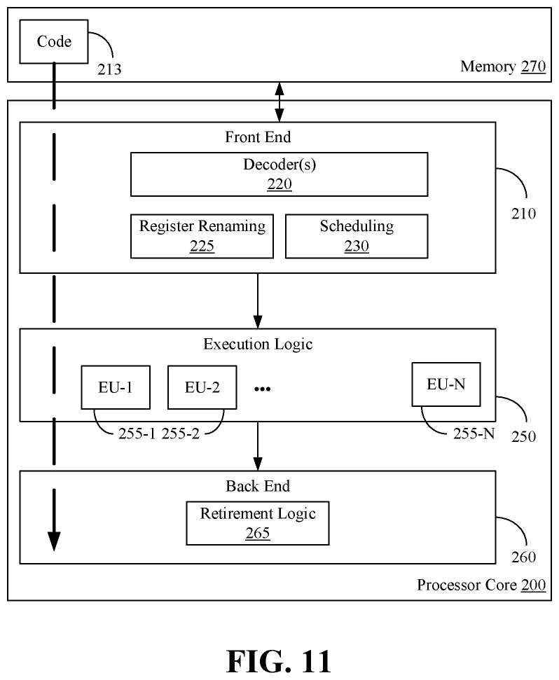

FIG. 11 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 11, a processing element may alternatively include more than one of the processor core 200 illustrated in FIG. 11. The processor core 200 may be a single-threaded core or, for at least one embodiment, the processor core 200 may be multithreaded in that it may include more than one hardware thread context (or “logical processor”) per core.

FIG. 11 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement method 300 (FIG. 2), architecture 400 (FIG. 3), method 350 (FIG. 4), method 500 (FIG. 5), process 520 (FIG. 6), operation 530 (FIG. 7) and/or method 540 (FIG. 8) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 11, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

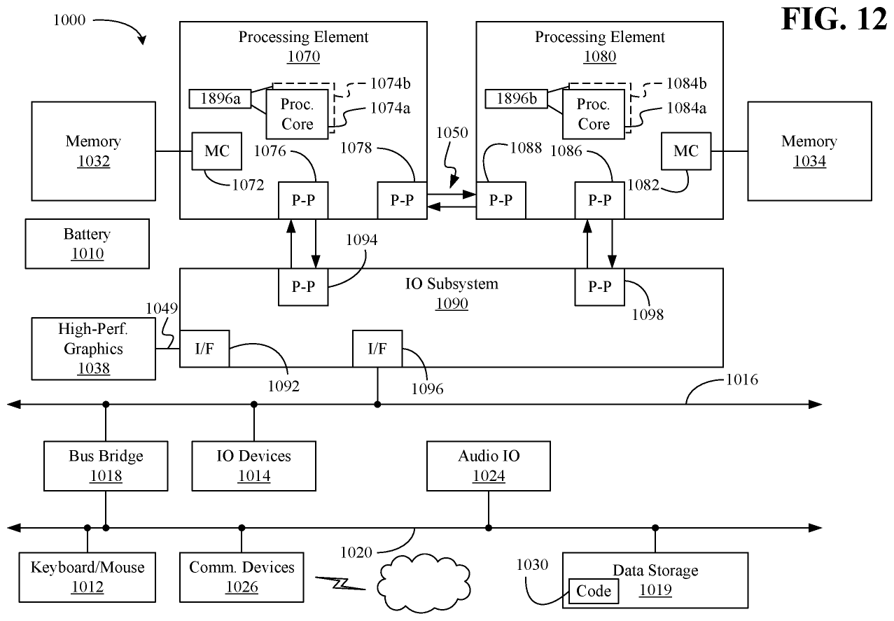

Referring now to FIG. 12, shown is a block diagram of a computing system 1000 embodiment in accordance with an embodiment. Shown in FIG. 12 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 12 may be implemented as a multi-drop bus rather than point-to-point interconnect.

As shown in FIG. 12, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 11.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 12, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 12, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 10, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 300 (FIG. 2), architecture 400 (FIG. 3), method 350 (FIG. 4), method 500 (FIG. 5), process 520 (FIG. 6), operation 530

(FIG. 7) and/or method 540 (FIG. 8), already discussed. Further, an audio I/O 1024 may be coupled to second bus 1020 and a battery 1010 may supply power to the computing system 1000.

Note that other embodiments are contemplated. For example, instead of the point-to-point architecture of FIG. 10, a system may implement a multi-drop bus or another such communication topology. Also, the elements of FIG. 10 may alternatively be partitioned using more or fewer integrated chips than shown in FIG. 10.

### ADDITIONAL NOTES AND EXAMPLES

Example 1 includes a performance-enhanced computing system comprising a network controller to communicate with a plurality of compute nodes associated with a neural network, a processor coupled to the network controller, and a memory including a set of executable program instructions, which when executed by the processor, cause the computing system to identify an embedding table to be associated with a neural network, wherein the neural network is to be associated with the plurality of compute nodes, identify a number of entries of the embedding table, and determine whether to process gradients associated with the embedding table as dense gradients or sparse gradients based on the number of entries.

Example 2 includes the computing system of Example 1, wherein the instructions, when executed, further cause the computing system to compare the number of entries to a threshold to determine whether to process the gradients associated with the embedding table as the dense gradients or the sparse gradients.

Example 3 includes the computing system of Example 2, wherein the instructions, when executed, further cause the computing system to generate the threshold based on a batch size to be processed by the neural network.

Example 4 includes the computing system of Example 1, wherein the instructions, when executed, further cause the computing system to determine that the gradients associated with the embedding table are to be processed as the dense gradients, maintain a plurality of instances of the embedding table in the computing system and the plurality of compute nodes, generate sparse gradients during a machine learning process that is to be executed based on the embedding table, map the sparse gradients generated during the machine learning process to generated dense gradients, average the generated dense gradients, and update the plurality of instances based on the generated dense gradients. Example 5 includes the computing system of Example 1, wherein the instructions, when executed, further cause the computing system to execute a vertical division process on the embedding table to generate a plurality of subdivided embedding tables that is to be less than an identified memory capacity associated with the plurality of compute nodes, and distribute the plurality of subdivided embedding tables to the plurality of compute nodes and the computing system.

Example 6 includes the computing system of any one of Examples 1 to 5, wherein the neural network is a deep learning neural network.

Example 7 includes a semiconductor apparatus associated with a plurality of compute nodes, comprising one or more substrates, and logic coupled to the one or more substrates, wherein the logic is implemented in one or more of configurable logic or fixed-functionality logic hardware, the logic coupled to the one or more substrates to identify an embedding table to be associated with a neural network, wherein the neural network is to be associated with the plurality of compute nodes, identify a number of entries of the embedding table, and determine whether to process gradients associated with the embedding table as dense gradients or sparse gradients based on the number of entries.

Example 8 includes the semiconductor apparatus of Example 7, wherein the logic is to compare the number of entries to a threshold to determine whether to process the gradients associated with the embedding table as the dense gradients or the sparse gradients.

Example 9 includes the semiconductor apparatus of Example 8, wherein the logic is to generate the threshold based on a batch size to be processed by the neural network. Example 10 includes the semiconductor apparatus of Example 7, wherein the logic is to determine that the gradients associated with the embedding table are to be processed as the dense gradients, maintain a plurality of instances of the embedding table in the plurality of compute nodes, generate sparse gradients during a machine learning process that is to be executed based on the embedding table, map the sparse gradients generated during the machine learning process to generated dense gradients, average the generated dense gradients, and update the plurality of instances based on the generated dense gradients.

Example 11 includes the semiconductor apparatus of Example 7, wherein the logic is to execute a vertical division process on the embedding table to generate a plurality of subdivided embedding tables, wherein each of the plurality of subdivided embedding tables is to be less than an identified memory capacity associated with the plurality of compute nodes, and distribute the plurality of subdivided embedding tables to the plurality of compute nodes.

Example 12 includes the semiconductor apparatus of any one of Examples 7 to 11, wherein the neural network is a deep learning neural network.

Example 13 includes the semiconductor apparatus of any one of Examples 7 to 11, wherein the logic coupled to the one or more substrates includes transistor channel regions that are positioned within the one or more substrates.

Example 14 includes at least one computer readable storage medium comprising a set of instructions, which when executed by one or more of a plurality of compute nodes, cause the one or more of the plurality of compute nodes to identify an embedding table to be associated with a neural network, wherein the neural network is to be associated with the plurality of compute nodes, identify a number of entries of the embedding table, and determine whether to process gradients associated with the embedding table as dense gradients or sparse gradients based on the number of entries.

Example 15 includes the at least one computer readable storage medium of Example 14, wherein the instructions, when executed, cause the one or more of the plurality of compute nodes to compare the number of entries to a threshold to determine whether to process the gradients associated with the embedding table as the dense gradients or the sparse gradients.

Example 16 includes the at least one computer readable storage medium of Example 15, wherein the instructions, when executed, cause the one or more of the plurality of compute nodes to generate the threshold based on a batch size to be processed by the neural network.

Example 17 includes the at least one computer readable storage medium of Example 14, wherein the instructions, when executed, cause the one or more of the plurality of compute nodes to determine that the gradients associated with the embedding table are to be processed as the dense gradients, maintain a plurality of instances of the embedding table in the plurality of compute nodes, generate sparse gradients during a machine learning process that is to be executed based on the embedding table, map the sparse gradients generated during the machine learning process to generated dense gradients, average the generated dense gradients, and update the plurality of instances based on the generated dense gradients.

Example 18 includes the at least one computer readable storage medium of Example 14, wherein the instructions, when executed, cause the one or more of the plurality of compute nodes to execute a vertical division process on the embedding table to generate a plurality of subdivided embedding tables, wherein each of the plurality of subdivided embedding tables is to be less than an identified memory capacity associated with the plurality of compute nodes, and distribute the plurality of subdivided embedding tables to the plurality of compute nodes.

Example 19 includes the at least one computer readable storage medium of any one of Examples 14 to 18, wherein the neural network is a deep learning neural network.

Example 20 includes a method comprising identifying an embedding table associated with a neural network, wherein the neural network is associated with a plurality of compute nodes, identifying a number of entries of the embedding table, and determining whether to process gradients associated with the embedding table as dense gradients or sparse gradients based on the number of entries.

Example 21 includes the method of Example 20, further comprising comparing the number of entries to a threshold to determine whether to process the gradients associated with the embedding table as the dense gradients or the sparse gradients.

Example 22 includes the method of Example 21, further comprising generating the threshold based on a batch size for processing by the neural network.

Example 23 includes the method of Example 20, further comprising determining that the gradients associated with the embedding table will be processed as the dense gradients, maintaining a plurality of instances of the embedding table in the plurality of compute nodes, generating sparse gradients during a machine learning process that is executed based on the embedding table, mapping the sparse gradients generated during the machine learning process to generated dense gradients, averaging the generated dense gradients, and updating the plurality of instances based on the generated dense gradients.

Example 24 includes the method of Example 20, further comprising executing a vertical division process on the embedding table to generate a plurality of subdivided embedding tables, wherein each of the plurality of subdivided embedding tables is less than an identified memory capacity associated with the plurality of compute nodes, and distribute the plurality of subdivided embedding tables to the plurality of compute nodes.

Example 25 includes the method of any one of Examples 20 to 24, wherein the neural network is a deep learning neural network.

Example 26 includes a semiconductor apparatus comprising means for identifying an embedding table associated with a neural network, wherein the neural network is associated with a plurality of compute nodes, means for identifying a number of entries of the embedding table, and means for determining whether to process gradients associated with the embedding table as dense gradients or sparse gradients based on the number of entries.

Example 27 includes the semiconductor apparatus of Example 26, further comprising means for comparing the number of entries to a threshold to determine whether to process the gradients associated with the embedding table as the dense gradients or the sparse gradients.

Example 28 includes the semiconductor apparatus of Example 27, further comprising means for generating the threshold based on a batch size for processing by the neural network.

Example 29 includes the semiconductor apparatus of Example 26, further comprising means for determining that the gradients associated with the embedding table are to be processed as the dense gradients, means for maintaining a plurality of instances of the embedding table in the plurality of compute nodes, means for generating sparse gradients during a machine learning process that is to be executed based on the embedding table, means for mapping the sparse gradients generated during the machine learning process to generated dense gradients, means for averaging the generated dense gradients, and means for updating the plurality of instances based on the generated dense gradients. Example 30 includes the semiconductor apparatus of Example 26, further comprising means for executing a vertical division process on the embedding table to generate a plurality of subdivided embedding tables, wherein each of the plurality of subdivided embedding tables is less than an identified memory capacity associated with the plurality of compute nodes, and means for distributing the plurality of subdivided embedding tables to the plurality of compute nodes.

Example 31 includes the semiconductor apparatus of any one of Examples 26 to 30, wherein the neural network is to be a deep learning neural network.

Thus, technology described herein may provide for an enhanced neural network process. Embodiments as described herein enable a multitude of enhancements, including lower processing time, reduced power footprints due to the efficiencies noted herein, and/or enhanced hardware allocations (e.g., reduced memory footprints).

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-25. (canceled)

26. A computing system comprising:
a network controller to communicate with a plurality of compute nodes associated with a neural network;
a processor coupled to the network controller; and
a memory including a set of executable program instructions, which when executed by the processor, cause the computing system to:
identify an embedding table to be associated with a neural network, wherein the neural network is to be associated with the plurality of compute nodes;
identify a number of entries of the embedding table; and
determine whether to process gradients associated with the embedding table as dense gradients or sparse gradients based on the number of entries.

27. The computing system of claim 26, wherein the instructions, when executed, further cause the computing system to:
compare the number of entries to a threshold to determine whether to process the gradients associated with the embedding table as the dense gradients or the sparse gradients.

28. The computing system of claim 27, wherein the instructions, when executed, further cause the computing system to:
generate the threshold based on a batch size to be processed by the neural network.

29. The computing system of claim 26, wherein the instructions, when executed, further cause the computing system to:
determine that the gradients associated with the embedding table are to be processed as the dense gradients;
maintain a plurality of instances of the embedding table in the computing system and the plurality of compute nodes;
generate sparse gradients during a machine learning process that is to be executed based on the embedding table;
map the sparse gradients generated during the machine learning process to generated dense gradients;
average the generated dense gradients; and
update the plurality of instances based on the generated dense gradients.

30. The computing system of claim 26, wherein the instructions, when executed, further cause the computing system to:
execute a vertical division process on the embedding table to generate a plurality of subdivided embedding tables that is to be less than an identified memory capacity associated with the plurality of compute nodes; and
distribute the plurality of subdivided embedding tables to the plurality of compute nodes and the computing system.

31. The computing system of claim 26, wherein the neural network is a deep learning neural network.

32. A semiconductor apparatus associated with a plurality of compute nodes, comprising:
one or more substrates; and
logic coupled to the one or more substrates, wherein the logic is implemented in one or more of configurable logic or fixed-functionality logic hardware, the logic coupled to the one or more substrates to:
identify an embedding table to be associated with a neural network, wherein the neural network is to be associated with the plurality of compute nodes;
identify a number of entries of the embedding table; and
determine whether to process gradients associated with the embedding table as dense gradients or sparse gradients based on the number of entries.

33. The semiconductor apparatus of claim 32, wherein the logic is to:
compare the number of entries to a threshold to determine whether to process the gradients associated with the embedding table as the dense gradients or the sparse gradients.

34. The semiconductor apparatus of claim 33, wherein the logic is to:
generate the threshold based on a batch size to be processed by the neural network.

35. The semiconductor apparatus of claim 32, wherein the logic is to:
determine that the gradients associated with the embedding table are to be processed as the dense gradients;
maintain a plurality of instances of the embedding table in the plurality of compute nodes;
generate sparse gradients during a machine learning process that is to be executed based on the embedding table;
map the sparse gradients generated during the machine learning process to generated dense gradients;
average the generated dense gradients; and
update the plurality of instances based on the generated dense gradients.

36. The semiconductor apparatus of claim 32, wherein the logic is to:
execute a vertical division process on the embedding table to generate a plurality of subdivided embedding tables, wherein each of the plurality of subdivided embedding tables is to be less than an identified memory capacity associated with the plurality of compute nodes; and
distribute the plurality of subdivided embedding tables to the plurality of compute nodes.

38. The semiconductor apparatus of claim 32, wherein the neural network is a deep learning neural network.

39. The semiconductor apparatus of claim 32, wherein the logic coupled to the one or more substrates includes transistor channel regions that are positioned within the one or more substrates.

40. At least one computer readable storage medium comprising a set of instructions, which when executed by one or more of a plurality of compute nodes, cause the one or more of the plurality of compute nodes to:
identify an embedding table to be associated with a neural network, wherein the neural network is to be associated with the plurality of compute nodes;
identify a number of entries of the embedding table; and
determine whether to process gradients associated with the embedding table as dense gradients or sparse gradients based on the number of entries.

41. The at least one computer readable storage medium of claim 40, wherein the instructions, when executed, cause the one or more of the plurality of compute nodes to:
compare the number of entries to a threshold to determine whether to process the gradients associated with the embedding table as the dense gradients or the sparse gradients.

42. The at least one computer readable storage medium of claim 41, wherein the instructions, when executed, cause the one or more of the plurality of compute nodes to:
generate the threshold based on a batch size to be processed by the neural network.

43. The at least one computer readable storage medium of claim 40, wherein the instructions, when executed, cause the one or more of the plurality of compute nodes to:
determine that the gradients associated with the embedding table are to be processed as the dense gradients;
maintain a plurality of instances of the embedding table in the plurality of compute nodes;
generate sparse gradients during a machine learning process that is to be executed based on the embedding table;
map the sparse gradients generated during the machine learning process to generated dense gradients;
average the generated dense gradients; and
update the plurality of instances based on the generated dense gradients.

44. The at least one computer readable storage medium of claim 40, wherein the instructions, when executed, cause the one or more of the plurality of compute nodes to:
execute a vertical division process on the embedding table to generate a plurality of subdivided embedding tables, wherein each of the plurality of subdivided embedding tables is to be less than an identified memory capacity associated with the plurality of compute nodes; and
distribute the plurality of subdivided embedding tables to the plurality of compute nodes.

45. The at least one computer readable storage medium of claim 44, wherein each of the plurality of compute nodes has a different subdivided embedding table of the plurality of subdivided embedding tables.

46. The at least one computer readable storage medium of claim 40, wherein the neural network is a deep learning neural network.
